(19) United States
(12) Patent Application Publication
(10) Pub. No.: US 2025/0156262 A1
(43) Pub. Date: May 15, 2025

(54) MODEL-BASED UPDATING OF CALL HOME DATA

(71) Applicant: INTERNATIONAL BUSINESS MACHINES CORPORATION, ARMONK, NY (US)

(72) Inventors: STEPHANIE CARYS SHUM, WAPPINGERS FALLS, NY (US); PASQUALE A. CATALANO, WALLKILL, NY (US); JEFFREY BISTI, NEW PALTZ, NY (US); JAYAPREETHA NATESAN, HOPEWELL JUNCTION, NY (US); KURT RODRIGO MANRIQUE NINO, WAPPINGERS FALLS, NY (US)

(21) Appl. No.: 18/507,196

(22) Filed: Nov. 13, 2023

(51) Int. Cl. G06F 11/07; G06F 16/16

(52) U.S. Cl. CPC G06F 11/079; G06F 16/164

(57) ABSTRACT

Model-based updating of call home data includes receiving problem analysis data associated with a computing system, and determining one or more reference codes associated with one or more defects within the problem analysis data. A portion of problem analysis data to utilize as training data for a model is determined based on data usage associated with the one or more defects. A representation of each of the one or more reference codes within the portion of problem analysis data is input to the model. The model is configured to output one or more data confidence scores based on the one or more reference codes. The association of the one or more reference codes with the one or more defects is updated based on the one or more data confidence scores.

### BACKGROUND

The present disclosure relates to methods, apparatus, and products for model-based updating of call home data.

### SUMMARY

According to embodiments of the present disclosure, various methods, apparatus and products for model-based updating of call home data are described herein. In some aspects, model-based updating of call home data includes receiving problem analysis data associated with a computing system, and determining one or more reference codes associated with one or more defects within the problem analysis data. A portion of problem analysis data to utilize as training data for a model is determined based on data usage associated with the one or more defects. A representation of each of the one or more reference codes within the portion of problem analysis data is input to the model. The model is configured to output one or more data confidence scores based on the one or more reference codes. The association of the one or more reference codes with the one or more defects is updated based on the one or more data confidence scores.

### BRIEF DESCRIPTION OF THE DRAWINGS

FIG. 1 sets forth an example computing environment according to aspects of the present disclosure.

FIG. 2 sets forth another example computing environment according to aspects of the present disclosure.

FIG. 3 sets forth an example of a process flow for the computing environment of FIG. 2 according to aspects of the present disclosure.

FIG. 4 sets forth a flowchart of an example process for model-based updating of call home data limits according to aspects of the present disclosure.

FIG. 5 sets forth a flowchart of another example process for model-based updating of call home data according to aspects of the present disclosure.

### DETAILED DESCRIPTION

Problem analysis data is used for identifying and correcting defects, such as software or hardware errors, which may arise related to a service or other programs provided by a computing system. The problem analysis data includes information related to identifying a cause of the defect such as files created or accessed during providing of the service, and is often collected at the computing system by one or more agents during execution of the service or program. For defects that are not readily repairable locally at the computing system, the problem analysis data is often transmitted to a service provider associated with the computing system for further analysis, referred to as a “call home” communication. The service provider may then determine steps necessary for correcting the defect and either communicate the steps to a customer associated with the computing system or perform the steps remotely to correct the defect.

In problem analysis, reference codes that are called home are mapped to sets of data that are to be collected to assist in resolving a defect. A reference code is a code value that is indicative of a diagnostic result of the computing system associated with a particular defect. For example, different types of hardware or software defects/errors or diagnostic results may be assigned a unique reference code. The mappings of the reference code to data are typically determined by each reference code owner. However, there are times when data is only identified as necessary to resolving a defect after the initial decision to act on the problem has occurred. This causes a gap in the collection of data that is needed to resolve a problem. In addition, as reference code owners change or leave, the knowledge base and understanding to determine exactly what data is necessary to resolve a defect can be lost.

Various embodiments for model-based updating of call home data in which an error or defect is identified to be acted upon (e.g., a call home) in which problem analysis data collection regarding the error or defect is to begin. After being identified as a problem situation to be acted upon, data usage by defect resolvers is tracked to allow for identification of data useful for resolving the error or defect within the problem analysis data. In a particular embodiment, heatmap tracking of data usage is utilized to reprioritize files or other data within the problem analysis data to identify the data within the problem analysis data useful for resolving the particular defect. The identified problem analysis data is used as training data for a model. The model receives as input crafted vector associations of a long-term corpus of problem analysis data as reference code representations, and outputs a data confidence scoring. The output is dynamically fed back into the reference code-to-data mappings along with predetermined data allowing for future call homes to take advantage of a more intelligently crafted set of problem analysis data. In one or more embodiments, the model is a machine-learning model such as a support vector machine, neural network, decision tree, or any other suitable machine-learning model.

In particular embodiments, the training model takes as input reference code vector associations, i.e., where each reference code is vectorized with features based on the problem corpus, with training data that utilizes the heatmap tracking of data usage, and outputs data confidence scorings. In particular embodiments, features for the vectorization of the reference codes may include one or more fields in the problem analysis data, related defect linking (e.g., a link created between related defects in the problem analysis data), and/or sentence embeddings related to textual information found in the problem analysis data. One or more embodiments, the reference code to data association is dynamically updated in which the data confidence scoring is used to identify which sets of data within the problem analysis data are necessary to include for each reference code.

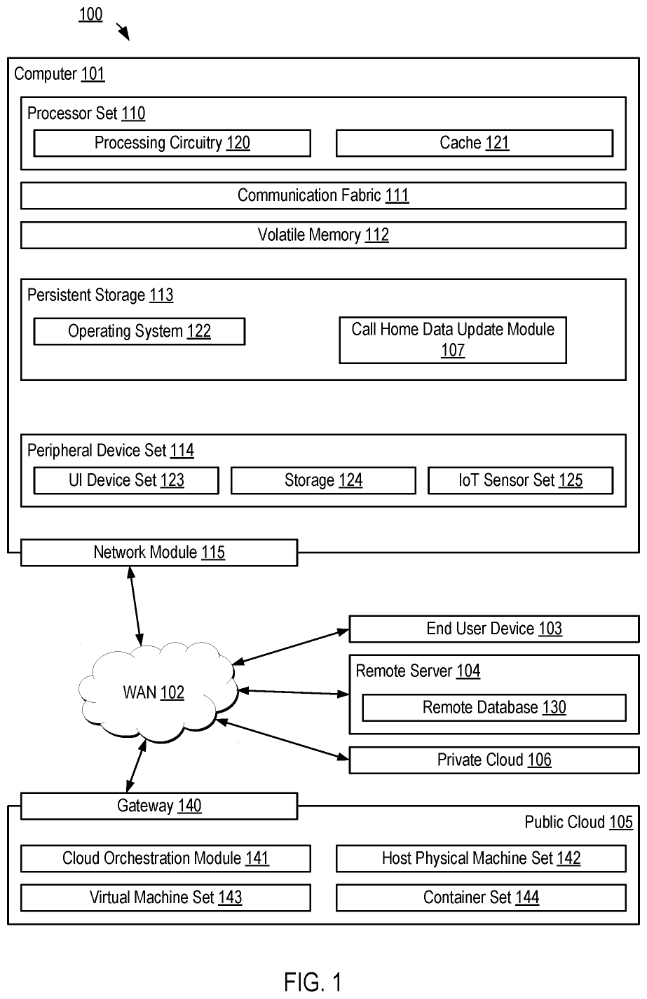

FIG. 1 sets forth an example computing environment according to aspects of the present disclosure. Computing environment 100 contains an example of an environment for the execution of at least some of the computer code involved in performing the various methods described herein, such as call home data update module 107. In addition to call home data update module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and call home data update module 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Such computer processors as well as graphic processors, accelerators, coprocessors, and the like are sometimes referred to herein as a processing device. A processing device and a memory operatively coupled to the processing device are sometimes referred to herein as an apparatus. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in call home data update module 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in call home data update module 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

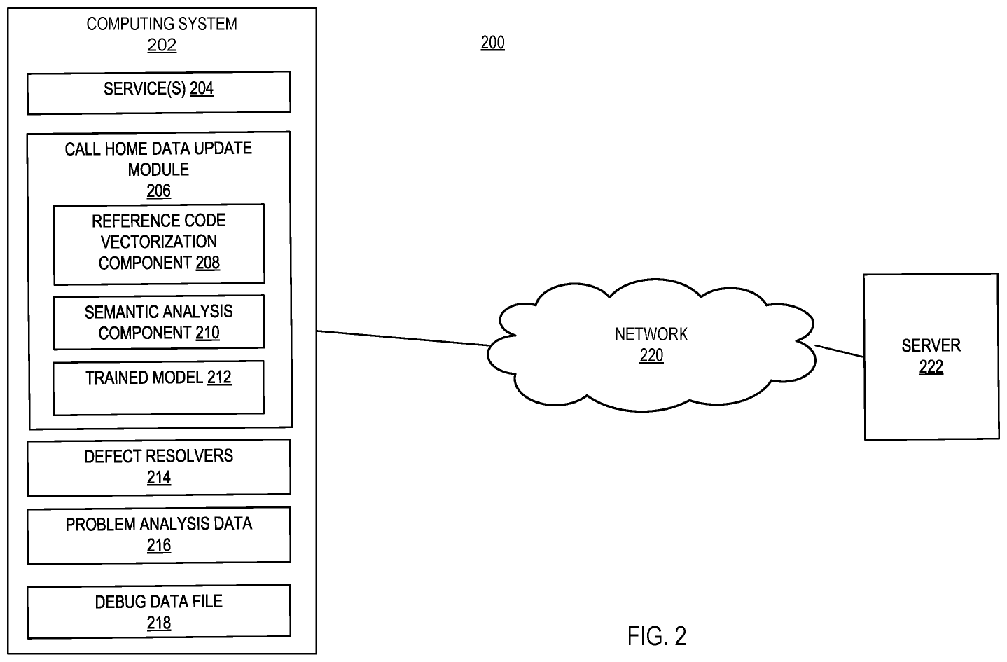

Referring now to FIG. 2, FIG. 2 sets forth another example computing environment according to aspects of the present disclosure. Computing environment 200 includes a computing system 202. In a particular embodiment, the computing system 202 includes the computer 101 described with respect to FIG. 1. The computing system 202 includes one or more services 204 and a call home data update module 206. The one or more services 204 may include one or more services being provided by the computing system 202 such as database services. The call home data update module 206 includes a reference code vectorization component 208, a semantic analysis component 210, and a trained model 212. The reference code vectorization component 208 is configured to determine a vector representation of one or more reference codes within problem analysis data 216 as described herein with respect to various embodiments. The semantic analysis component 210 is configured to perform semantic analysis, such as natural language processing (NPL), upon the problem analysis data 216 to identify data within the problem analysis data 216 that may be relevant to a particular defect as described herein with respect to various embodiments. For example, the semantic analysis component 210 may use semantic parsing to identify particular keywords or phrases within the problem analysis data 216 that is relevant to a particular defect.

The trained model 212 is configured to be trained with training data utilizing tracked data usage associated with one or more defects, receive vectorized reference codes as input, and output one or more confidence scores associated with the reference codes as described herein with respect to various embodiments. The trained model 212 is further configured to dynamically update reference code to data associations based upon the confidence scores. Upon a subsequent occurrence of the same or a related defect, the model may provide more relevant problem analysis data to allow an improved analysis of a defect. As the trained model 212 is continually trained, the accuracy of the trained model 212 in identifying relevant data in the problem analysis data for resolving a particular defect is improved. In an embodiment, the call home data update module 206 includes the call home data update module 107 of FIG. 1.

The computing system 202 further includes one or more defect resolvers 214 configured to detect particular defects within the computing system 202 and generated usage data indicative of a frequency of access, use, or creation of particular files or other data during occurrence of and/or attempts to resolve the defect. In particular embodiments, the one or more defect resolvers 214 may include software components configured to monitor and detect particular defects. In other embodiments, the defect resolvers may include users performing defect analysis and resolution functions. The computing system 202 is further configured to generate a debug data file 218 based upon a portion of the problem analysis data 216 identified by the trained model 212 as being useful for resolution of a defect.

The computing environment 200 further includes a server 222 in communication with the computing system 202 via a network 220. In a particular embodiment, the server 222 is associated with a service provider of the one or more services 204. In one or more embodiments, the computing system 202 is configured to transmit the debug data file 218 to the server 222 for analysis to determine a cause of the defect.

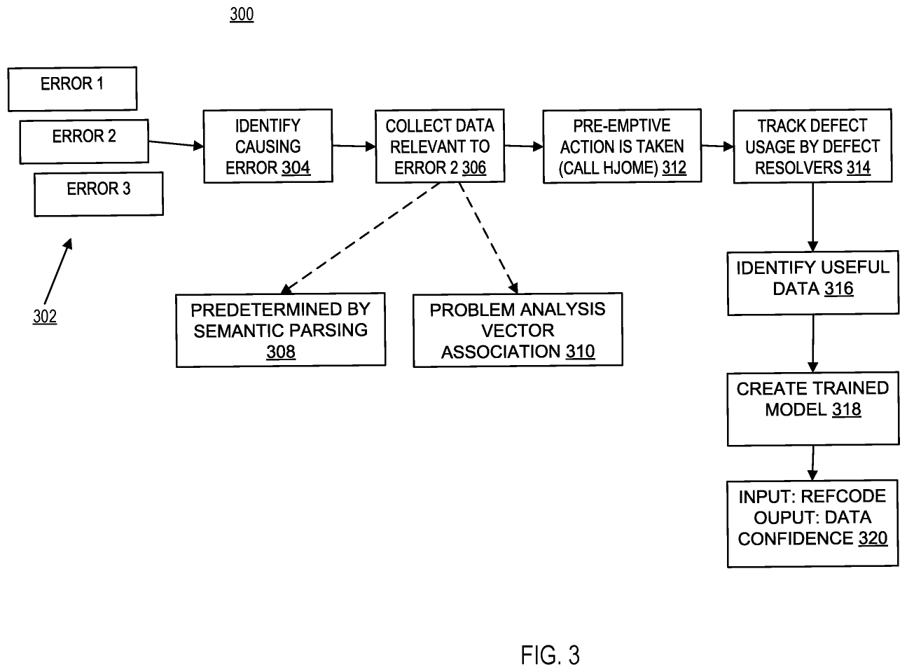

Referring now to FIG. 3 sets forth an example of a process flow for the computing environment of FIG. 2 according to aspects of the present disclosure. In the process flow 300 the computing system 202 identifies 304 an error (Error 2) as a causing error of a defect in the computing system 202 from among a plurality of possible errors (e.g., Error 1, Error 2, Error 3) 302. In a particular embodiment, the error is a software or hardware error associated with a service provided by the computing system 202. The computing system 202 collects 306 data relevant to Error 2 from among a corpus of problem analysis data 216. In a particular embodiment, the computing system 202 collects a portion of predetermined data relevant to Error 2 by semantic parsing 308, and another portion of data using problem analysis vector association 310. For example, semantic parsing 308 may be utilized to identify predetermined words or phrases within the problem analysis data 216 that is particularly relevant to a defect or error. In another example, problem analysis vector association 310 may be used to vectorize reference codes as described herein with respect to various embodiments.

The computing system 202 may optional take 312 a pre-emptive action by initiating a call home to the server 222. The computing system 202 tracks 314 defect usage by defect resolvers to determine usage data related to identification and/or resolution of various defects such as a frequency of access or creation of particular files or other data related to the defects. The computing system 312 identifies 316 identifies useful data for training the model by determining a portion of the problem analysis data 216 to utilize as training data for the model based on the data usage associated with the one or more defects.

The computing system 202 creates 318 a trained model configured to be trained with training data utilizing the tracked data usage associated with one or more defects. The trained model is configured to receive 320 vectorized reference codes as input, and output one or more data confidence scores associated with the reference codes as described herein with respect to various embodiments.

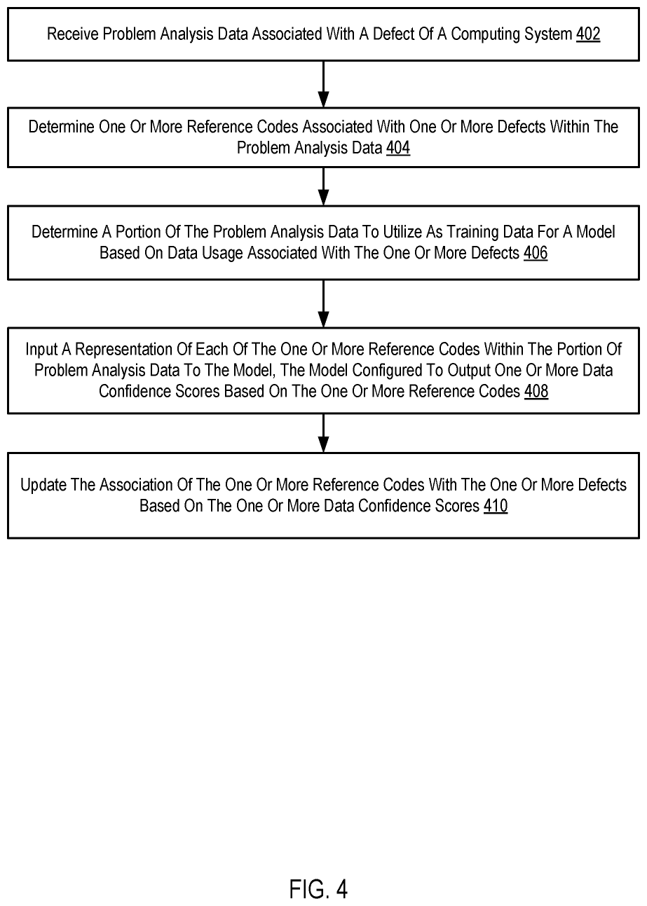

Referring now to FIG. 4, FIG. 4 sets forth a flowchart of an example process for model-based updating of call home data according to aspects of the present disclosure. The computing system 202 receives 402 problem analysis data associated with a computing system. In one or more embodiments, the process of FIG. 4 is initiated by determining that a defect has occurred in the computing system 202 such as a hardware or software defect in a service provided by the computing system 202. In a particular embodiment, the problem analysis data comprises a data file.

The computing system 202 determines 404 one or more reference codes associated with one or more defects within the problem analysis data. In particular embodiments, the one or more reference codes are each indicative of a diagnostic result of the computing system 202 associated with the one or more defects. The computing system 202 determines 406 a portion of the problem analysis data to utilize as training data for a model based on data usage associated with the one or more defects. In particular embodiments, the computing system 202 determines the portion of problem analysis data to utilize as training data for the model further by semantically parsing the problem analysis data to determine a portion of the problem analysis data relevant to the defect.

The computing system 202 inputs 408 a representation of each of the one or more reference codes within the portion of problem analysis data to the model. The model is configured to output one or more data confidence scores based on the one or more reference codes. In particular embodiments, the representation of each of the one or more reference codes comprises a vector-based representation. The computing system 202 updates 410 the association of the one or more reference codes with the one or more defects based on the one or more data confidence scores.

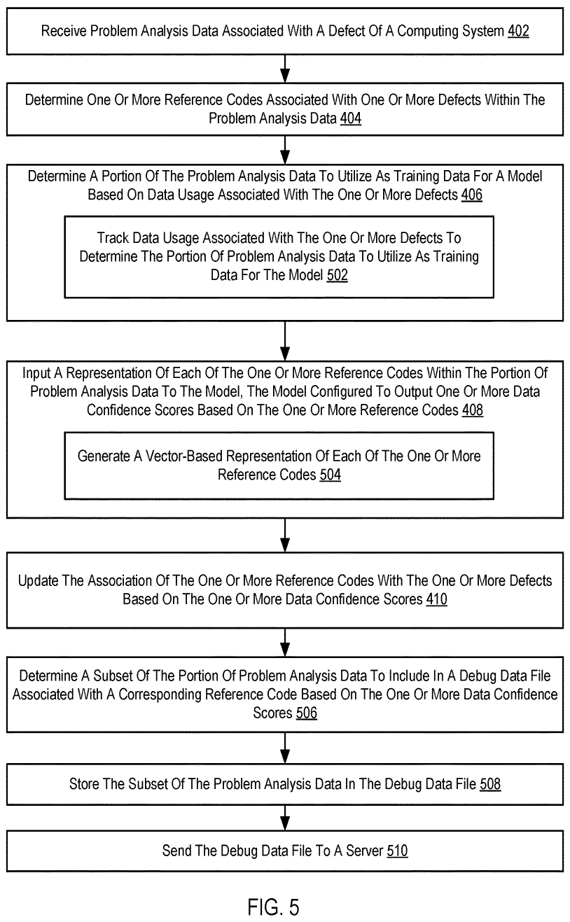

Referring now to FIG. 5, FIG. 5 sets forth a flowchart of another example process for updating call home data limits and priorities according to aspects of the present disclosure. The example process of FIG. 5 includes the steps described with respect to the example process of FIG. 4 and further includes wherein determining 406 the portion of problem analysis data to utilize as training data for the model based on data usage associated with the one or more defects includes tracking 502 data usage associated with the one or more defects to determine the portion of problem analysis data to utilize as training data for the model. In a particular embodiment, tracking the data usage associated with the one or more defects comprises tracking data usage associated with the one or more defects using a heatmap.

In the example process of FIG. 5, inputting 408 the representation of each of the one or more reference codes within the portion of problem analysis data to the model includes generating 504 a vector-based representation of each of the one or more reference codes. In particular embodiments, the vector-based representation of each of the one or more reference codes is generated based on one or more features found in the corpus of problem analysis data. In particular embodiments, features for the vectorization of the reference codes may include one or more fields in the problem analysis data, related defect linking (e.g., a link created between related defects in the problem analysis data), and/or sentence embeddings related to textual information found in the problem analysis data.

The example process of FIG. 5 further includes the computing system 202 determining 506 a subset of the portion of problem analysis data to include in a debug data file associated with a corresponding reference code based on the one or more data confidence scores. The computing system 202 stores 508 the subset of the problem analysis data in the debug data file and sends 510 the debug data file to a server. In a particular embodiment, the server determines a resolution of the defect based on the debug data file and communicates the resolution of the defect to the computing system 202. In another particular embodiment, one or more users associated with a service provider utilize the debug data file to determine a resolution to the defect. The one or more users associated with the service provider may communicate the resolution to the computing system 202 and/or users associated with the computing system 202, or perform an action to resolve the defect.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving problem analysis data associated with a computing system;
determining one or more reference codes associated with one or more defects within the problem analysis data;
determining a portion of the problem analysis data to utilize as training data for a model based on data usage associated with the one or more defects;
inputting a representation of each of the one or more reference codes within the portion of problem analysis data to the model, the model configured to output one or more data confidence scores based on the one or more reference codes; and
updating the association of the one or more reference codes with the one or more defects based on the one or more data confidence scores.

2. The method of claim 1, wherein determining the portion of problem analysis data to utilize as training data for the model based on data usage associated with the one or more defects comprises tracking data usage associated with the one or more defects to determine the portion of problem analysis data to utilize as training data for the model.

3. The method of claim 2, wherein tracking the data usage associated with the one or more defects comprises tracking data usage associated with the one or more defects using a heatmap.

4. The method of claim 1, wherein determining the portion of problem analysis data to utilize as training data for the model further comprises semantically parsing the problem analysis data to determine a portion of the problem analysis data relevant to the defect.

5. The method of claim 1, wherein the representation of each of the one or more reference codes comprises a vector-based representation.

6. The method of claim 1, wherein the one or more reference codes are each indicative of a diagnostic result of the computing system associated with the one or more defects.

7. The method of claim 1, determining a subset of the portion of problem analysis data to include in a debug data file associated with a corresponding reference code based on the one or more data confidence scores.

8. The method of claim 7, further comprising storing the problem analysis data in the debug data file.

9. The method of claim 1, wherein the defect comprises a software defect of the computing system.

10. The method of claim 1, wherein the problem analysis data comprises a data file.

11. The method of claim 7, further comprising sending the debug data file to a server.

12. An apparatus comprising:
a processing device; and
memory operatively coupled to the processing device, wherein the memory stores computer program instructions that, when executed, cause the processing device to:
receive problem analysis data associated with a computing system;
determine one or more reference codes associated with one or more defects within the problem analysis data;
determine a portion of the problem analysis data to utilize as training data for a model based on data usage associated with the one or more defects;
input a representation of each of the one or more reference codes within the portion of problem analysis data to the model, the model configured to output one or more data confidence scores based on the one or more reference codes; and
update the association of the one or more reference codes with the one or more defects based on the one or more data confidence scores.

13. The apparatus of claim 12, wherein determining the portion of problem analysis data to utilize as training data for the model based on data usage associated with the one or more defects comprises tracking data usage associated with the one or more defects to determine the portion of problem analysis data to utilize as training data for the model.

14. The apparatus of claim 12, wherein determining the portion of problem analysis data to utilize as training data for the model further comprises semantically parsing the problem analysis data to determine a portion of the problem analysis data relevant to the defect.

15. The apparatus of claim 12, wherein the representation of each of the one or more reference codes comprises a vector-based representation.

16. The apparatus of claim 12, wherein the one or more reference codes are each indicative of a diagnostic result of the computing system associated with the one or more defects.

17. A computer program product comprising a computer readable storage medium, wherein the computer readable storage medium comprises computer program instructions that, when executed:
receive problem analysis data associated with a computing system;
determine one or more reference codes associated with one or more defects within the problem analysis data;
determine a portion of the problem analysis data to utilize as training data for a model based on data usage associated with the one or more defects;
input a representation of each of the one or more reference codes within the portion of problem analysis data to the model, the model configured to output one or more data confidence scores based on the one or more reference codes; and
update the association of the one or more reference codes with the one or more defects based on the one or more data confidence scores.

18. The computer program product of claim 17, wherein determining the portion of problem analysis data to utilize as training data for the model based on data usage associated with the one or more defects comprises tracking data usage associated with the one or more defects to determine the portion of problem analysis data to utilize as training data for the model.

19. The computer program product of claim 17, wherein determining the portion of problem analysis data to utilize as training data for the model further comprises semantically parsing the problem analysis data to determine a portion of the problem analysis data relevant to the defect.

20. The computer program product of claim 17, wherein the representation of each of the one or more reference codes comprises a vector-based representation.
